(19) United States
(12) Patent Application Publication
(10) Pub. No.: US 2005/0041570 A1
(43) Pub. Date: Feb. 24, 2005

(54) Optical disc construction

(76) Inventor: Donald Richard Hone, Wrightstown, PA (US)

Correspondence Address: Gilbert W Rudman;Atofina Chemicals Inc, Patent Department 26th Floor, 2000 Market Street, Philadelphia, PA, 19103-3222, US

(21) Appl. No.: 10/478,892

(22) PCT Filed: Apr. 18, 2003
(86) PCT No.: PCT/US03/11839

Related U.S. Application Data
(60) Provisional application No. 60/374,106, filed on Apr. 22, 2002.

(51) Int. Cl. G11B 3/70; G11B 7/26

(52) U.S. Cl. 369/282; 369/288

(57) ABSTRACT

An optical disc such as a digital versatile disc (DVD) includes plural substrates which are bonded together to form a single disc structure. One of the substrates is manufactured so that regions of the substrate forming the central hub which is provided to receive the disc within its protective packaging case and in a disc player during playback operation have a thickness which is greater than the thickness of the reminder of the substrate, strengthening the central hub and improving the durability of the manufactured disc by increasing resistance to cracking failure along the inner diameter of the disc.

### BACKGROUND OF THE INVENTION

This invention generally relates to optical discs of various constructions. More particularly, the present invention relates to laminated discs of the type commonly referred to as “digital versatile discs” or “DVD's”.

Digital versatile discs, or DVD's, are generally comprised of two or more substrates which contain one or more layers of information on one or more recording surfaces. Such discs are typically comprised of multiple substrates, usually two, which are prepared separately and which are then bonded together to form one complete disc. Information stored on the disc can be accessed from the disc from one oar both of its sides, depending on the particular disc format.

A variety of DVD formats are in common use today and other DVD formats are currently in the development stage. Such formats can be broadly classified as pre-recorded formats, e.g., DVD-ROM and DVD video formats, or recordable and/or re-writeable formats, e.g., DVD-R, DVD-RAM, DVD-RW and DVD-R+W formats. Each of these formats shares the same basic multi-disc structure, as previously described.

Pre-recorded DVD's have permanent information encoded at the time of their manufacture, for subsequent playback by the consumer. Recordable and/or re-writeable DVD's are supplied as blank discs for recording use by the customer. “Write once” discs, such as DVD-R, can be recorded once while “re-writeable” discs, such as DVD-RAM, can be recorded and re-recorded many times.

Discs of both classifications can also be described by their amount of storage capacity and the manner in which the stored information is accessed by the reading laser. These descriptions presently include, as examples, DVD-5 discs (one layer of information accessed from one side of the disc), DVD-10 discs (two layers of information, each accessed from opposing sides of the disc), DVD-9 discs (two layers of information, both accessed from the same side of the disc), DVD-14 discs (three layers of information, two accessed from one side of the disc and one accessed from the opposing side of the disc) and DVD-18 discs (four layers of information, two layers accessed from each side of the disc).

The designation numbers for these discs, i.e., 5, 10, 9, 14 and 18, respectively, refer to the storage capacity of the disc based on encoding which can be read by a red laser of a typical 635 nm or 650 nm wavelength. The approximate capacities of these formats are 4.7, 9.4, 8.5, 13.2 and 17.0 Gbytes, respectively. Employing a shorter wavelength laser, e.g., 400 nm, further increases each of the above-described capacities by permitting the preparation and reading of discs containing smaller pit or groove features. In any event, the overall disc structure (multiple bonded substrates with reflective layers) remains the same. The numerical designation is changed to reflect the actual storage capacity of the resulting disc.

FIG. 1 illustrates a common configuration for such discs, in the example selected for illustration, a DVD-5 disc. Common practice for the manufacture of such a disc 1 entails the preparation of two half discs 2, 3. The half discs 2, 3 are most commonly manufactured using an injection molding process, although any of a variety of other manufacturing processes can also be used. The two half discs 2, 3 are then bonded together, using a layer 4 of a known adhesive, to form a single disc 1.

Each of the half discs 2, 3 is formed from a carrier substrate 5, 6. The carrier substrates 5, 6 are most commonly prepared from optically clear polymers, most often an acrylic polymer such as polycarbonate (PC) or polymethylmethacrylate (PMMA), although other materials can also be used. Each of the manufactured half discs 2, 3 generally has a thickness on the order of 0.6 mm and a diameter on the order of 120 mm.

One, or both of the half discs 2, 3, is prepared with pits, grooves or the like, for encoding the data (information) which is to be stored on the DVD. The selected data-encoding medium is formed in a surface of the half disc, for example, the inwardly facing surface 7 of the half disc 3. Disc surfaces containing information are preferably coated with a reflective surface 8, or a dye, for subsequent reading or recording using a laser 9 in a DVD player. In the structure illustrated, a reflective layer 8, for example, a sputtered aluminum or silver alloy, has been applied to the surface 7 of the substrate 3.

The very thin nature of the half discs 2, 3 (i.e., on the order of 0.6 mm) makes them especially prone to cracking at the inner diameter 10 which forms the “central hub” area 11 which is typically used to center and secure the disc 1 in its protective packaging case and in a disc player during playback operation. Stresses imposed on the disc 1 during insertion and removal either from the packaging and/or a disc player can cause cracking in the material forming the disc 1 along the inner diameter 10. Severe cracking can render the disc unplayable, making it desirable to eliminate the potential for cracking at the central hub 11.

### SUMMARY OF THE INVENTION

In accordance with the present invention, an optical disc, for example, a digital versatile disc (DVD), is comprised of plural half discs which are bonded together to form a single disc structure. One of the half discs is manufactured so that regions of the substrate forming the half disc which form the central hub which is provided to receive the disc within its protective packaging case and in a disc player during playback operation have a thickness which is greater than the thickness of the reminder of the substrate. This serves to strengthen the central hub, improving the durability of the manufactured disc by increasing resistance to cracking failure along the inner diameter of the disc.

### BRIEF DESCRIPTION OF THE DRAWINGS

FIG. 1 is a schematic, cross-sectional view of a known optical disc construction.

FIGS. 2 and 3 are schematic, cross-sectional views showing alternative embodiments of an optical disc constructed in accordance with the present invention.

### DETAILED DESCRIPTION OF THE INVENTION

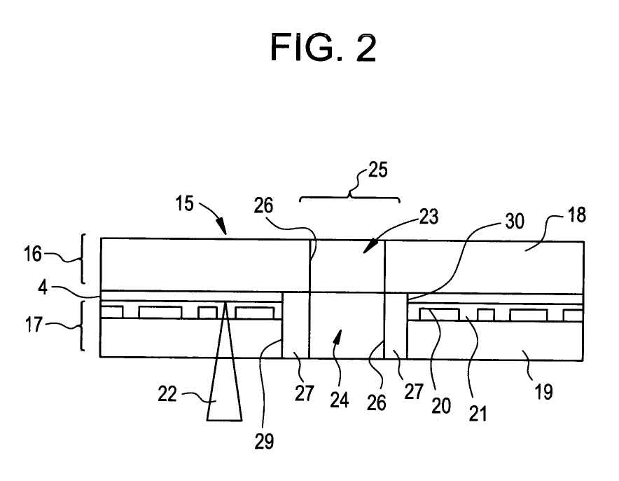

FIG. 2 illustrates the structure of a disc 15 which has been manufactured in accordance with the present invention. The disc 15 selected for illustration in FIG. 2 is, again, a DVD-5 disc. It is to be understood, however, that a DVD-5 disc has been selected only for purposes of illustration and that any of a variety of digital versatile discs (DVD's), including those previously described, as well as compact discs (CD's) and other disc constructions that have been developed or that may be developed in the future, may benefit from the improvements to be described below.

The disc 15 is formed as an assembly of two half discs 16, 17. The half discs 16, 17 can be manufactured using the polymer processing equipment which is typically used in the manufacture of DVD substrates, including injection molding, injection-compression molding and extrusion process equipment, as well as any of a variety of other manufacturing processes. The two half discs 16, 17 are then appropriately encoded, metallized, and bonded together to form a single disc 15. This is generally followed by desired printing, again using known manufacturing techniques.

Each of the half discs 16, 17 is formed from a carrier substrate 18, 19. The carrier substrates 18, 19 can be prepared from optically clear polymers, including acrylic polymers such as polycarbonate (PC) or polymethylmethacrylate (PMMA), from non-optical polymer combinations including materials such as acrylonitrile-butadiene-styrene (ABS), or from other materials. In any event, each of the manufactured half discs 16, 17 will generally be manufactured with a thickness on the order of 0.6 mm and a diameter on the order of 120 mm to accommodate existing disc playing and disc recording equipment.

In the illustrated case, one of the half discs 17 (or, for other disc constructions, potentially both of the half discs) is prepared with pits, grooves or the like, for encoding the data (information) which is to be stored on the resulting DVD. The data-encoding medium used is formed in a surface of the half disc, for example, the inwardly facing surface 20 of the half disc 17. The information-bearing disc surface 20 is coated with a reflective layer 21 formed, for example, of a sputtered aluminum or silver alloy, for subsequent reading or recording using a laser 22 in otherwise known fashion. The half disc 17 is then joined with the half disc 16, to complete the disc 15, using any of a variety of known adhesives (the layer 4).

During manufacture, each of the half discs 16, 17 is provided with an aperture 23, 24. The apertures 23, 24 of the half discs 16, 17 combine, following assembly, to develop the central hub 25 which is typically used to center and secure the disc 15 in a protective packaging case during storage and in a disc player during playback operation.

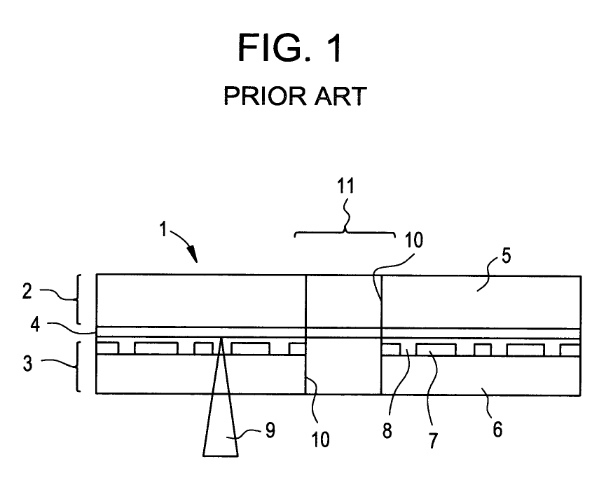

Resulting from the manufacture of prior discs to present standards, i.e., with a total thickness typically on the order of 1.2 mm, the half discs 2, 3 forming the disc 1 shown in FIG. 1 were found to be especially prone to cracking at the inner diameter 10 which defines the central hub area 11. Stresses imposed on the disc 1 during insertion and removal either from the packaging and/or a disc player could cause cracking in the material forming the disc 1 along the inner diameter 10 which could render the disc unplayable.

In accordance with the present invention, the potential for such cracking is materially reduced by providing the center portion of one of the half discs with an increased thickness. In FIG. 2, the thickness of the central hub 25 has been increased by extending center portions of the half disc 16 into the half disc 17. However, it would also be possible to increase the thickness of the central hub 25 by extending center portions of the half disc 17 into the half disc 16, if desired. It would also be possible to associate the portions of increased thickness with more than one of the half discs. This, however, is presently considered less preferred because it tends to make the manufacturing process somewhat more complex. The increased thickness of the central hub 25 provides a central hub which is more robust, in turn increasing resistance of the central hub to cracking at the inner diameter 26 and improving the overall durability of the disc 15.

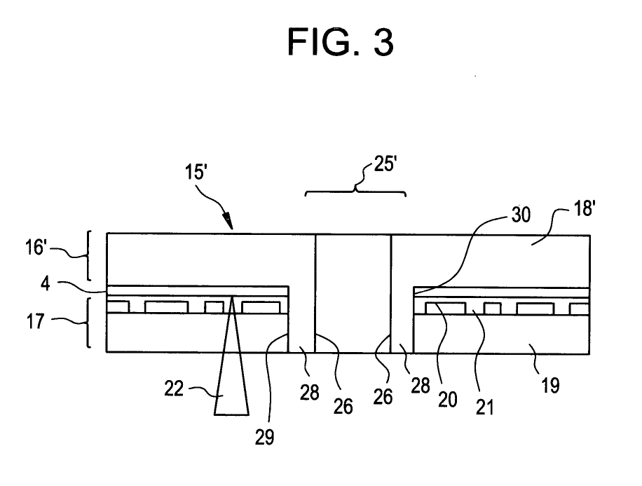

Referring to FIG. 2, the center portion of increased thickness can be developed by placing a separate shoulder 27 onto the substrate 16, either using an adhesive or as part of the manufacturing process. Referring to FIG. 3, which is in all other respects similar to the construction shown in FIG. 2, the center portion of increased thickness can be formed as an integral part 28 of the substrate 16′, which is presently considered preferred. If the center portion is implemented as a separate shoulder 27, (FIG. 2), the material forming the shoulder 27 can be the same as, or different from, the material forming the substrate 16, and a manufacturing process such as multi-shot molding or insert molding would preferably be used. If the center portion is formed as an integral structure 28, (FIG. 3), the same material will be used to form the entire center portion, and a manufacturing process such as injection molding, injection-compression molding or extrusion would preferably be used.

To maintain a proper assembly of the disc, the inner diameter 29 of the half disc 17 which does not include the central hub 25 is accordingly increased, to accommodate the increased thickness of the central hub 25 and in this way provide the disc 15 with a substantially uniform overall thickness. Making the thickness of the central hub 25 equal to the overall thickness of the laminated disc 15 insures compliance with existing specifications for optical discs of this general construction, and readability of the manufactured discs in standard disc players.

As an example of typical dimensions for the disc 15 having a central hub 25 of increased thickness in accordance with the present invention, each half disc 16, 17 will typically have a thickness on the order of 0.6 mm, yielding a disc 15 having a total thickness on the order of 1.2 mm, which is the present standard for this industry. Producing a disc 15 with a minimum thickness on the order of 1.0 mm, with each half disc 16, 17 having a minimum thickness on the order of 0.5 mm, would be possible, resulting from the improved structural integrity of a central hub 25 produced in accordance with the present invention, but the existing standards for such optical discs would then also have to be changed.

A standard is presently set for the diameter of the central hub 25 which is on the order of 15 mm. The inner diameter 29 of the mating half disc 17, which does not include the center portion of increased thickness, will typically be on the order of 17 mm. Providing a shoulder 27 (or an integral structure 28) with a thickness on the order of 1 mm is presently considered most convenient for modification of the existing tooling used to manufacture standard disc structures. A smaller shoulder 27 (or integral structure 28), having a thickness on the order of 0.5 mm could also be developed, if desired, yielding an inner diameter 29 for the mating half disc 17 on the order of 16 mm. The inner diameter 29 is preferably kept to a minimum to avoid interfering with the recordable (data-receiving) area available on the disc 15, which once again is an industry-defined standard.

Changes in the foregoing parameters are possible, but in each case, the existing standards for optical discs would have to be changed. The foregoing parameters will also vary with the particular type of optical disc (existing, or developed in the future) which is being manufactured. Other modifications will also be appropriate for different types of discs, including those mentioned previously as well as types of discs that may come to be developed in the future.

Further economies can also be gained by employing alternate substrate production techniques, such as using discs which are die cut from extruded (0.6 mm) sheet materials. For the previously described DVD-5 type discs, which have been selected for purposes of illustration only, the non-information carrying substrate 16 is referred to as a “dummy disc”. The structure of the dummy disc 16 has characteristics similar to those of the primary substrate 17, to insure disc readability, and both discs can be prepared from flat sheet materials, if desired.

It will therefore be understood that various changes in the details, materials and arrangement of parts which have been herein described and illustrated in order to explain the nature of this invention may be made by those skilled in the art within the principle and scope of the invention as expressed in the following claims.

1. An optical disc comprising at least two half discs which are combined to form the optical disc, wherein each of the half discs includes a substrate having a substantially uniform thickness, and an aperture formed in center portions of the substrate having a defined diameter;
wherein a first half disc has a first aperture which defines a central hub for supporting the optical disc, and wherein the central hub of the first half disc has a thickness which is greater than the thickness of the substrate of the first half disc; and
wherein a second half disc has a second aperture, and wherein the diameter of the second aperture is greater than the diameter of the first aperture and the central hub defined by the first aperture.

2. The optical disc of claim 1 wherein the central hub has an outer diameter for mating with the second aperture, and wherein the outer diameter of the central hub substantially corresponds to the diameter of the second aperture.

3. The optical disc of claim 2 wherein the diameter of the first aperture is about 15 mm.

4. The optical disc of claim 3 wherein the diameter of the second aperture is at least 16 mm.

5. The optical disc of claim 4 wherein the diameter of the second aperture is about 17 mm.

6. The optical disc of claim 1 wherein the thickness of the central hub substantially corresponds to a thickness equal to the thickness of the substrate of the first half disc and the thickness of the substrate of the second half disc.

7. The optical disc of claim 6 wherein the thickness of the central hub is at least 1 mm.

8. The optical disc of claim 7 wherein the thickness of the central hub is about 1.2 mm.

9. The optical disc of claim 7 wherein the thickness of the substrate of the first half disc is substantially equal to the thickness of the substrate of the second half disc.

10. The optical disc of claim 1 wherein the first substrate and the second substrate are formed of a material selected from the group of substrate materials consisting essentially of acrylic polymers including polycarbonate (PC), polymethylmethacrylate (PMMA), and non-optical polymer combinations including acrylonitrile-butadiene-styrene (ABS).

11. The optical disc of claim 10 wherein the first substrate and the second substrate are formed of the same material.

12. The optical disc of claim 10 wherein the first substrate and the second substrate are formed of different materials.

13. The optical disc of claim 1 wherein the central hub includes a shoulder mated with the first substrate.

14. The optical disc of claim 13 wherein the shoulder and the first substrate are formed of the same material.

15. The optical disc of claim 13 wherein the shoulder and the first substrate are formed of different materials.

16. The optical disc of claim 13 wherein the shoulder has a thickness of at least 0.5 mm.

17. The optical disc of claim 16 wherein the shoulder has a thickness of about 1.0 mm.

18. The optical disc of claim 1 wherein the first substrate and the central hub are formed as a unitary structure.

19. The optical disc of claim 18 wherein the unitary structure includes an extension having a thickness of at least 0.5 mm.

20. The optical disc of claim 19 wherein the extension has a thickness of about 1.0 mm.

21. The optical disc of claim 1 wherein a surface of the substrate of one of the half discs includes data-encoding structures.

22. The optical disc of claim 21 wherein a coating covers the surface which includes the data-encoding structures.

23. The optical disc of claim 21 wherein a surface of the substrate of the first half disc and a surface of the substrate of the second half disc each include data-encoding structures.

24. The optical disc of claim 23 wherein a coating covers the surfaces which include the data-encoding structures.

25. An optical disc comprising at least two half discs which are combined to form the optical disc, wherein each of the half discs includes a substrate having a substantially uniform thickness, and an aperture formed in center portions of the substrate having a defined diameter;
(a) wherein a first half disc has a first aperture which defines a central hub for supporting the optical disc, and wherein the central hub of the first half disc has a thickness which is greater than the thickness of the substrate of the first half disc;
(b) wherein a second half disc has a second aperture, and wherein the diameter of the second aperture is greater than the diameter of the first aperture and the central hub defined by the first aperture;
(c) wherein the central hub has an outer diameter for mating with the second aperture, and wherein the outer diameter of the central hub substantially corresponds to the diameter of the second aperture; and
(d) wherein the thickness of the central hub substantially corresponds to a thickness equal to the thickness of the substrate of the first half disc and the thickness of the substrate of the second half disc.

26. The optical disc of claim 25 wherein the diameter of the first aperture is about 15 mm.

27. The optical disc of claim 26 wherein the diameter of the second aperture is at least 16 mm.

28. The optical disc of claim 27 wherein the diameter of the second aperture is about 17 mm.

29. The optical disc of claim 25 wherein the thickness of the central hub is at least 1 mm.

30. The optical disc of claim 29 wherein the thickness of the central hub is about 1.2 mm.

31. The optical disc of claim 29 wherein the thickness of the substrate of the first half disc is substantially equal to the thickness of the substrate of the second half disc.

32. The optical disc of claim 25 wherein the central hub includes a shoulder mated with the first substrate.

33. The optical disc of claim 32 wherein the shoulder and the first substrate are formed of the same material.

34. The optical disc of claim 32 wherein the shoulder and the first substrate are formed of different materials.

35. The optical disc of claim 32 wherein the shoulder has a thickness of at least 0.5 mm.

36. The optical disc of claim 35 wherein the shoulder has a thickness of about 1.0 mm.

37. The optical disc of claim 25 wherein the first substrate and the central hub are formed as a unitary structure.

38. The optical disc of claim 37 wherein the unitary structure includes an extension having a thickness of at least 0.5 mm.

39. The optical disc of claim 38 wherein the extension has a thickness of about 1.0 mm.
